(19) United States
(12) Patent Application Publication
(10) Pub. No.: US 2018/0161777 A1
(43) Pub. Date: Jun. 14, 2018

(54) MULTI-GRAIN DE-CLUMPER SYSTEM AND METHOD

(71) Applicant: Rayeman Elements, Inc., Berthoud, CO (US)

(72) Inventor: Michael R. Thomas, St. Clair, MO (US)

(73) Assignee: Rayeman Elements, Inc., Berthoud, CO (US)

(21) Appl. No.: 15/834,056

(22) Filed: Dec. 6, 2017

Related U.S. Application Data
(60) Provisional application No. 62/430,836, filed on Dec. 6, 2016.

(51) Int. Cl. B02C 4/08; B02C 4/06; B02C 23/06; A23K 40/10

(52) U.S. Cl. CPC B02C 4/08; B02C 4/06; B02C 4/30; A23K 40/10; B02C 23/06

(57) ABSTRACT

A device, system and method, according to various embodiments, for processing a granular material to produce a flowable granular composition having a flowable form, without the addition of an additive. The granular material is passed between multiple rotating screws, the particles within the granular material are broken down, and moisture within the granular material is released until it assumes a condition such that the flowable granular composition will not substantially clump or form bridges when the flowable granular composition is in a humid environment, in a subsequent process, during transport or during storage.

### REFERENCE TO RELATED APPLICATION

This application claims benefit to U.S. Provisional Patent Application Ser. No. 62/430,836, which was filed on Dec. 6, 2016. The subject matter of the earlier filed application is hereby incorporated by reference.

### DESCRIPTION OF THE INVENTION

### Field of the Invention

This invention relates to an apparatus and method for treating granular material such as wet distiller grain (WDG) or dried distiller grains (DDG) for the purpose of processing the grain in a manner that preserves the highest nutritional properties in the grain, yields the best grain color, de-clumps and creates a flowable grain.

### Background of the Invention

In the field of animal feed, granular material, such as wet and dried distiller “grains”, is a major feed source for farm livestock. Furthermore, granular materials are ubiquitous in our daily lives. They play an important role in many industries, such as mining, agriculture, civil engineering and pharmaceutical manufacturing. Because of their unusual physical properties, the physics of granular material has become the subject of a growing field of research. In some cases, granular material can exhibit fluid-like behavior. For example, dry grain has the properties to flow like a fluid. However, the properties of dry grain can change when the grain is wet. Adding liquid or moisture can alter the dynamics of grain flow.

A small amount of liquid added to a granular material can form “bridges” at the contact points between the grains. The surface energy of these bridges leads to an attractive force between the grains, which is absent in dry granular materials. Therefore, wetting changes, such as through moisture or mold, can change a granular system from one with only repulsive intergrain interactions to one with both repulsive and attractive interactions. The addition of even minuscule amounts of moisture can greatly increase these angles because of the cohesion between the grains.

The moisture effects on the dynamics of the grain flow is evident, because, when the wet grain falls, the grains do not move individually but in clumps. The formation of the clumps is a result of moisture or mold in the grain, which can form bridges. Oftentimes, when grain is initially processed in an upstream dryer apparatus, afterwards, the discharged grain is dumped into a pile, which forms a pyramid-shaped pile. The moisture can become trapped within the pyramid pile, which causes clumping and bridges. Another disadvantage associated with bridged grain is the suffocation hazards in grain storage bins. If the discharged grain is emptied into a storage bin and a worker enters the bin and stands on or below the “bridged” grain, the bridge can collapse, under the worker's weight or unexpectedly, thus, burying the worker. Suffocation can occur when the worker is engulfed (buried or covered) by the grain.

Sometimes, a free-flowing agent, also known as anti-caking agent, is used as an additive in a granular material to reduce stickiness and clumping problems so as to maintain a free flow. One feature of free-flowing/anti-caking agents is to absorb water from granular material, such as animal feed grain and food products. Conventional examples include FLO-GARD®, which is a silica product used as a free-flow/anti-caking agent in animal feed applications, and JELUCEL®, which is a powdered cellulose product used in powdered food applications. A system and method are needed that produce a dry final product capable of flowing freely and not clumping, without adding any additives.

Furthermore, there is a need for a system and process that preserves the highest nutritional properties in the grain, ultimately yields the lightest and best color grain, and de-clumps and creates flowable grain that does not bridge.

### SUMMARY OF THE INVENTION

The present invention may satisfy one or more of the above-mentioned desirable features. Other features and/or aspects may become apparent from the description which follows.

Various embodiments provide a system and process that preserves the highest nutritional properties in the grain, ultimately yields the lightest and best color grain, and de-clumps and creates flowable grain that does not bridge.

Various embodiments provide a high-nutritional grain, without additives, that does not clump and form bridges even after long storage or high temperature conditions.

In various embodiments, an apparatus and method are configured to produce an animal feed supplement using a screw arrangement that changes the properties of grain in such a manner to avoid the formation of clumps and/or brides.

In various embodiments, as the screws rotate, shearing and compressing of the distiller grain from the intermeshed flights causes a physical property change in the grain. This physical property change improves the dynamic of the grain flow creating a flowable grain that does not bridge.

### BRIEF DESCRIPTION OF THE DRAWINGS

The skilled artisan will understand that the drawings described below are for illustrative purposes only. The drawings are not intended to limit the scope of the present teachings in any way.

FIG. 1 shows a general schematic drawing of an exemplary embodiment of a system for producing a distiller grain in accordance with the present teachings;

FIG. 2 shows an example of a set of intermeshed twin screws which can be used in conjunction with the apparatus of the present teachings;

FIG. 3A shows an example of a side view of a temperature reducing mechanism in accordance with the present teachings;

FIG. 3B depicts a front view of the apparatus of FIG. 3A;

FIG. 4A shows another example of a temperature reducing mechanism in accordance with the present teachings;

FIG. 4B shows yet another example of a temperature reducing mechanism in accordance with the present teachings;

FIG. 5 shows another example of a temperature reducing mechanism in accordance with the present teachings;

FIG. 6 illustrates an operational flow chart of a method of producing distiller grain utilizing the apparatus in accordance with the present teachings;

FIG. 7A is a chart of the relative shear rate based on the screw geometry and rate per minute (rpm); and

FIG. 7B is a graph showing the relative sheer as a function of the screw starts and rate per minute (rpm).

### DETAILED DESCRIPTION OF VARIOUS EMBODIMENTS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term ‘about” mechanism +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize. While embodiments of the present technology are described herein primarily in connection with granular material, such as animal feed grain, the concepts are also applicable to other granular material used in industries, such as mining, food and agriculture, civil engineering and pharmaceutical.

Various embodiments provide a system and process that preserves the highest nutritional properties in the grain, ultimately yields the lightest and best color grain, and de-clumps and creates flowable grain that does not bridge.

In various embodiments, an apparatus and method are configured to produce an animal feed supplement using a screw arrangement that changes the properties of grain in such a manner to avoid the formation of clumps and/or bridges.

In various embodiments, as the screws rotate, shearing and compressing of the distiller grain from the intermeshed flights causes a physical property change in the grain. This physical property change improves the dynamic of the grain flow so as to de-clump the grain and create a flowable grain that does not bridge. When the shear rate is increased, the grains flow similar to an ordinary liquid. The system and method, according to the present teachings, increases the shear rate of the grain until it flows similar to a liquid state.

In addition to monitoring and regulating the shear rate of the grain, various embodiments described herein enable the optional cooling of grains and articles alike from a high temperature to a lower temperature by employing a multi-screw grain de-clumper system and method. In various embodiments, the system can be configured such that the grain enters a feed throat section of a barrel via hopper and encounters a set of intermeshing twin screws. The screws can rotate in a co-rotating or counter rotating manner. The grain is compressed between the screws such that the grain gets distributed between the flights of the intermeshing screws and the inner walls of the barrel that houses the screws. In various embodiments, the grain is spread in a substantially thin manner whereas the grain has a very high surface contact with the surface of the screws and barrel. The grain is conveyed in a direction from the feed throat towards the opposite end of the screws.

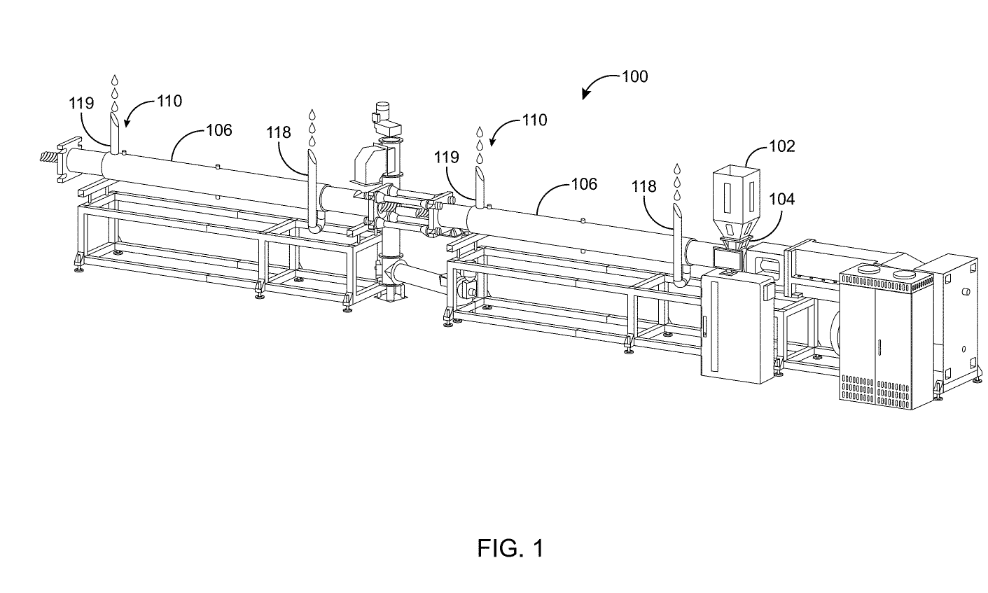

An exemplary embodiment of the apparatus 100 that can be used, for example, to prepare an animal feed according to the present teachings is illustrated in FIG. 1. FIG. 1 illustrates a schematic diagram of an exemplary extruder where an animal feed composition in the initial form of distiller grain material is processed into a final product. In the preferred embodiment, the distiller grain consists of wet distiller grain (WDG) or dried distiller grain (DDG). In some embodiments, different forms of distiller grains, for example, wet, or modified wet distiller grains, may be employed in various embodiments of the present teachings. Typically, wet distiller grain contains primarily unfermented grain residues (protein, fiber, fat and up to 70% moisture). In some applications, the wet distiller grain has a moisture content as high as 75% and, in other applications, the moisture content of the wet distiller grain may be higher but no more than 90%. Modified wet distiller grains may have a moisture content of approximately 50% to 55%. Dried distiller grains may have a moisture content of approximately 10% to 12%.

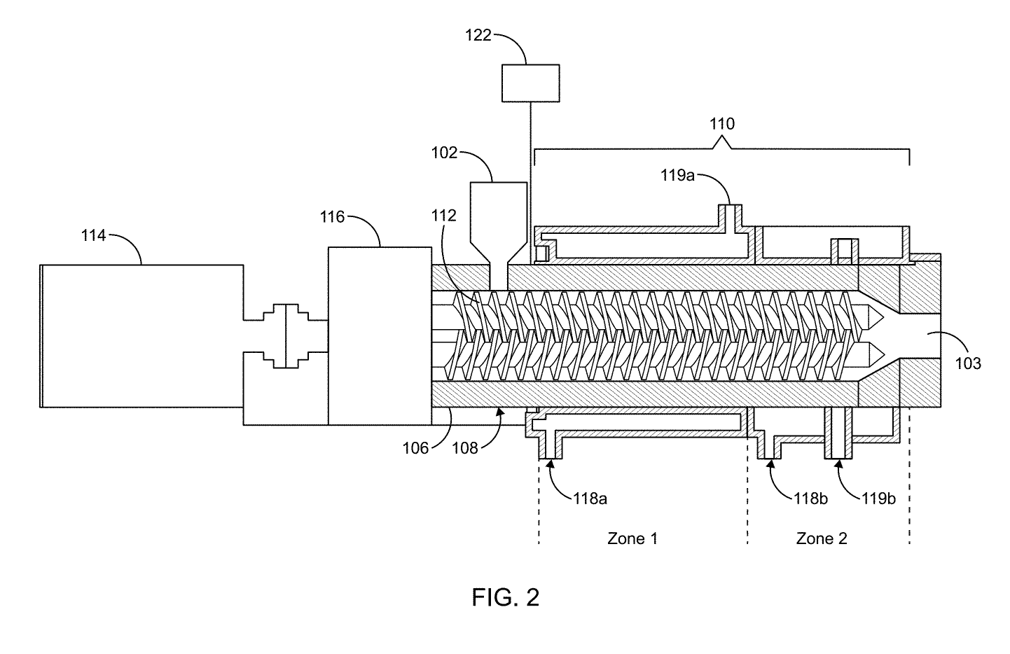

An exemplary embodiment of a system that can be used, for example, to produce a high-nutritional dry grain animal feed supplement is illustrated in FIGS. 1-2. The high-nutritional properties of the dry grain animal feed supplement, for example, may be high fat, high protein, high fiber, or a combination thereof in comparison to known industry standard animal feed grain. For example, the high-nutritional properties may include high fat within a range of about 6% to 14%, high protein within a range of about 27% to 58%, and high fiber within a range of about 17% to 50%. Referring to FIG. 1, the apparatus 100 can provide a loading zone for example, a hopper 102, for loading the granular material into the apparatus 100. Material supplied from hopper 102 in loose granular form is fed into the inlet chute 104 of the of an extruder 106. The apparatus 100 can be configured such that the grain enters a feed throat section of a barrel 108 via hopper 102 and encounters a multiple screw arrangement. The barrel 108, which houses the multiple screw arrangement, may be surrounded by one or more sources of a cooling medium 110.

In various embodiments, the apparatus 100 can be configured having several differing screws with differing structures or geometries that breaks down the initial size of the particles of the treated material and to release moisture from the treated material to avoid de-clumps and produce a flowable grain. The multiple-screws can be counter-rotating or co-rotating, intermeshing or non-intermeshing or a combination thereof. In various embodiments, the screws are configured such that the treated material may experience shearing cycles applied to the treated material as the treated material is conveyed from the extruder inlet at hopper 102 to the extruder outlet 103 of the screws. In FIG. 2, one example of a multiple screw arrangement of an extruder that can be employed within apparatus 100 is a set of counter-rotating, intermeshing twin screws 112. The counter-rotating, twin-screw extruder enables high shear upon the grain.

Those skilled in the art would recognize that a combination of a variety of multiple screws may be used to shear the treated material. The twin-screw extruders can be co-rotating with screws rotating in the same direction, or counter-rotating with screws rotating in the opposite direction. For example, the apparatus 100 may contain triple-screw extruders, quadruple-screw extruders, and screw extruders with ten screws arranged in a circular pattern. Therefore, in addition to the above-mentioned examples, various other modifications and alterations may be employed without departing from the scope of the present teachings.

In some embodiments, such extruders may be modular, and the screw design can be changed by rearranging the feeding, cooling, and mixing elements along the screw shaft. The multiple screw extruders can be configured having modular configurations, which makes the equipment quite flexible for adapting to changing applications and material properties. In various embodiments, the barrel and screw arrangements can be connected in series or in a parallel configuration, with the treated grain being distributed to subsequent sections via conveyors.

In the embodiments employing multiple screws, the treated material may be fed into the inlet of the housing thereby entraining the treated material between the rotating screws and then moving the treated material downward and out of the housing, as the screws rotate. As the grain advances through the twin screws 112 (FIG. 2), the grain may encounter several different stages. In general, the multiple screws having different numbers of flights and/or pitches generates substantial shear stress on the grain. In various embodiments, the screw flight may be designed having an angle in the direction as shown in FIG. 2. In other embodiments, the screw flight may be designed having an angle in a direction opposition as shown in FIG. 2, For example, the exemplary multiple screws may be designed to include one or more segments as follows: single pitch, single flight; short pitch, single flight; half pitch, single flight; long pitch, single flight; variable pitch, single flight; double flights, standard pitch; tapered, standard pitch, single flight; single cut-flight, standard pitch; and single flight ribbon.

As illustrated in the exemplary embodiment of FIG. 2, the screw of the extruder can be driven by a variable speed motor 114 and gearbox 116 that drive the screw element 112 of the extruder 106. The treated material in the form of grain, such as wet distiller grain or dried distiller grain bulk material, enters the extruder at hopper chute 102. The system can be configured to process wet distiller grain coming off a distillation process or dried distiller grain coming off a dryer. For example, the system can process grain having initial moisture levels in a range of 5%-95%. As the material is conveyed downward within the extruder 106, cooling may be added to the material by one or more sources of a cooling medium 110 along one or more zones of the barrel 108 of the extruder 106. In some embodiments, at least one or more non-cooling zone may be provided in the extruder such that no cooling medium applies additional cooling to the treated material. In other embodiments, the extruder may be designed having no source of a cooling medium.

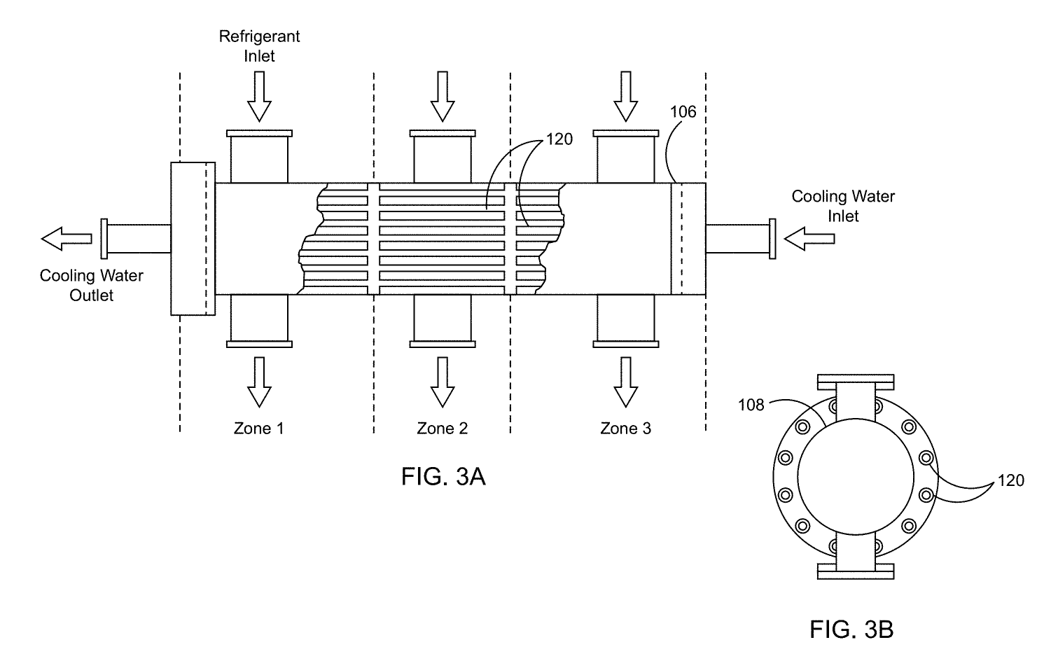

FIG. 2 illustrates depicts a side view of an example of the apparatus including cooling ports 118a, 118b, 119a, 119b. FIG. 3A depicts a side view of an example of the apparatus including passageway tubes 120. FIG. 3B depicts a front view of the apparatus including passageway tubes 120 in FIG. 3A. In the embodiments employing one or more cooling medium sources, such as the example in FIGS. 2 and 3A, the cooling media 110 shown in FIG. 1 can be arranged having a plurality of zones where the individual sources of cooling medium 110 can be equipped with independent controls for creating separate zones where desired temperatures are maintained in the treated material as it is conveyed down the extruder 106. While two zones are shown in FIG. 2 and three zones are shown in FIG. 3A, the number of actual zones employed could be greater or less than the zones shown depending on the requirements of the treated material and the design requirements of a particular system.

In various embodiments, the barrel 108 can be chilled in a series of smaller zones or in one large zone such that water, oil, water mixed with Cyclol, or any cooling medium alike can be circulated through a series of cooling ports 118, 118a, 118b, 119, 119a, 119b (FIGS. 1, 2, and 4A-4B) or water passageway tubes 120 (FIGS. 3A-3B). The cooling medium can be circulated through theses passageways 120 and/or ports 118, 119 in a closed loop manner or a non-closed loop manner by liquid pumps (not shown). In FIGS. 1, 2, 4A and 4B, the source of cooling medium 110 can include coolant inlets 118, 118a, 118b and coolant outlets 119, 119a, 119b. The coolant inlets 118, 118a, 118b and coolant outlets 119, 119a, 119b are interchangeable depending on the type of coolant flow desired.

The cooling medium may or may not be chilled by a central water chiller. In an embodiment of FIG. 3A-3B employing the central water chiller, the cooling medium may pass through a heat exchanger where the liquid cooling medium passes through one side of the heat exchanger and a liquid refrigerant or chilled liquid passes through the other side of the heat exchanger causing the temperature of the cooling medium to be reduced to a desired temperature. In FIGS. 3A-3B, the apparatus consists of a series of passageway tubes 120. One set of these tube contains the fluid to be cooled. The second fluid runs over the tubes that are being cooled so that it can reduce the moisture in the grain. The cooling media of the second fluid can be arranged according to the plurality of zones where individual sources of cooling medium can be operated individually or collectively to run over the tubes 120 for creating separate zones where desired temperatures are maintained in the treated material as it is conveyed down the extruder 106.

The liquid refrigerant or chilled liquid may be, for example, water, oil, a combination of water and glycol, or any type of liquid medium. These cooling ports 118, 118a, 118b, 119, 119a, 119b cooling ports or water passageway tubes 120 can be located, for example, at the surface of the barrel 108 that houses the screws where the flights of the screws are in contact with the inner surface of the screws. In various embodiments, the system can be configured with the water passageways or cooling ports positioned at locations different than at the surface where the flights of the screws are in contact with the inner surface of the screws.

In various embodiments, the barrel cooling zone(s) can be controlled by a controller 122 where one or more temperature sensors such as thermal couples T1, T2, T3 in each zone can be located, for example, substantially half-way or mid-way through the thickness of the barrel wall. The zones may all be individually controlled or one or more may be collectively controlled to maintain preselected temperature conditions in the treated grain as it travels along the multiple screw extruder 106. The thermal couple(s) sense the temperature of the barrel wall in a specific zone and provides feedback to the controller. Based on the feedback, the controller controls the valves 128, which may or may not be proportionate, and allows for an on/off and/or proportionate flow of cooling medium to flow through the water jackets or cooling ports. The flow of the cooling medium provides a desired temperature of the barrel zones that are in contact with the grain on the barrel's inner surface, which has a cooling effect on the grain being conveyed within the screws. The screws that are in contact with the grain can also be chilled to a desired temperature.

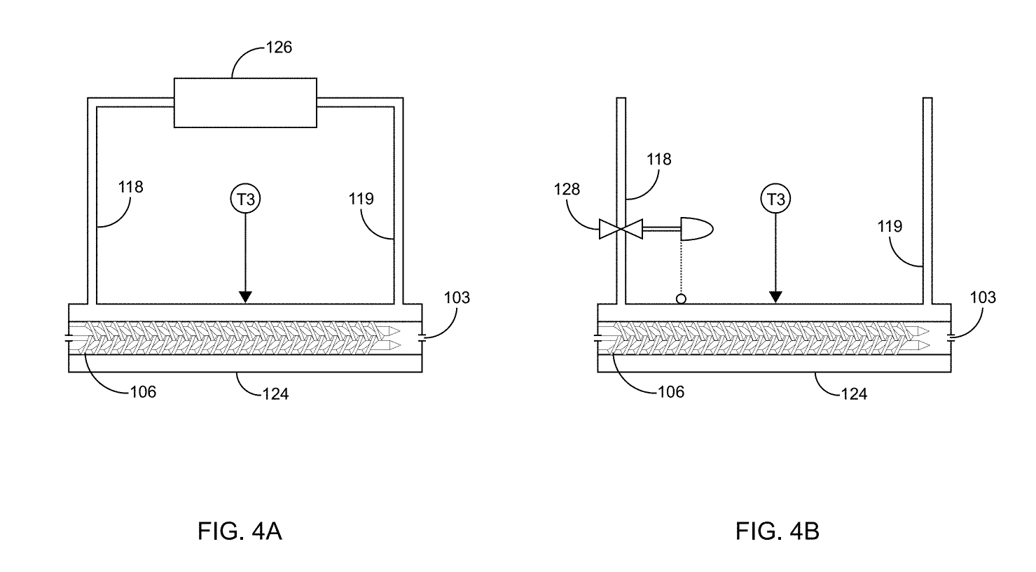

In FIG. 4A, as the treated grain advances through the extruder 106, the treated grain may be cooled in a heat exchanger assembly 124. In FIG. 4A, the heat exchanger assembly may use water as its cooling agent and the cooling water enters or exits the heat exchanger 124 by way of cooling port 118 and 119. Either of pipes 118 or 119 can be used as the entry point or exit point of the cooling water depending on the type of flow that is desired in the heat exchanger. In FIG. 4A, the heat exchanger 124 is cooled by a cooling medium processing device 126. The cooling medium processor 126 can be in the form of any known cooling system. A partial listing of cooling devices and methods that may be used would include cryogenic coolers, refrigerated air heat exchangers, water chillers, cooling towers and any other known cooling device or combination of cooling devices that are capable of cooling the treated distiller grain to a stable internal temperature before it is discharges as a final product.

In FIG. 4B, the control of the flow of the coolant to the heat exchanger 124 is regulated by control valve 128. Valve control regulator 128 can be set to maintain different cooling rates in heat exchanger 124. The valve control regulator 128 can also be functionally connected to temperature sensor 130 located in the heat exchanger 124 or in the barrel 108 to control the flow of coolant through valve 128 to maintain a desired temperature in the heat exchanger, the barrel, the screw, or treated grain.

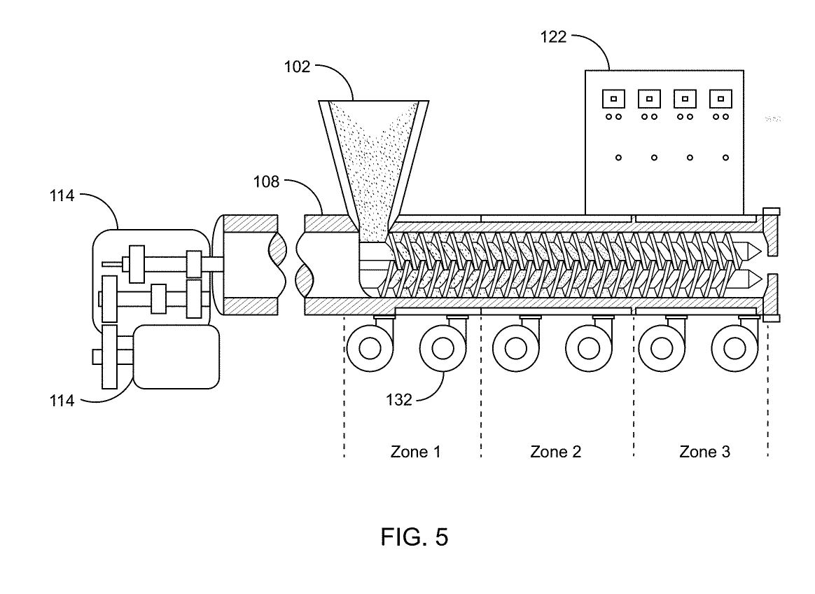

As illustrated in FIG. 5, an alternative method to cooling the barrel zones is to position one or more cooling fans 132 and ducting around each of the barrel zones so that the controller controls the rate of ambient air being circulated around the barrel surface.

These exemplary barrel and screw arrangements may be hooked up in series or in a parallel manner where the grain enters the feed throat of one barrel and exits at the opposite end of the barrel. Then, the grain enters through the next barrel and may continue in this manner until the desired temperature is reached based on the throughput of the grain through this system. The grain can be distributed from one barrel to the next barrel via flex augers, belt conveyors, or air conveyance.

In various embodiments, the screws can be driven by a gear box 116 that is driven by an electric motor 114, which is controlled by a variable speed drive that is controlled by a controller 122. This configuration enables the screws to rotate at a desired rpms to permit a sufficient amount of residence time in the screws for controlling and monitoring the shear rate and flowability of the treated grain and/or controlling the heat exchange to occur between the inner surface of the barrel and the outer surface of the screws via inductive/conductive heat transfer.

In general, the present teachings relate to an apparatus and method for producing a final product grain having the highest nutritional properties, ultimately yields the lightest and best color grain. The apparatus and method de-clump various grains, and similar residuals, as the grain advances through a multiple screw extruder and creates flowable grain that does not grain. The shear rate of the grain may be monitored and controlled to de-clump the grain and produce the flowable grain. Optionally, the apparatus and method may cool the grain from higher to lower temperatures as it advances through the multiple screw extruder.

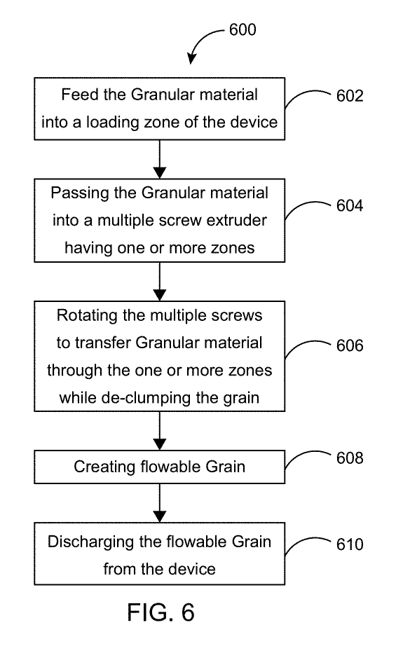

FIG. 6 illustrates an operational flow chart 600 of a method for producing the final grain product utilizing a device according to the present teachings. In block 602, granular material, such as distiller grain, is fed into a loading zone (hopper) of the device. The granular material is fed from the hopper and distributed in a thin layer over the high surface area of a multiple screw extruder. For example, the granular material may be applied to the high surface area of the multiple screws in a thin layer in a range of about 1 inch to 5 inches. In block 604, the granular material is passed into the multiple screw extruder having one or more controlled zones. The multiple screw extruder may include, for example, a unique set of counter-rotating, intermeshing twin screws enclosed in a barrel. In block 606, the grain advances along and between the multiple screws while de-clumping the grain. To facilitate the de-clumping of the grain as it moves along the screws, the shear rate of the grain can be monitored and regulated by a controller. In block 608, the multiple screws rotate and process the grain creating flowable grain. Then, in block 610, the flowable grain is discharged from the grain making them suitable for downstream processing, conveying, and/or storage.

Numerous studies, theoretical models, and algorithms have been developed to assess the flowability of grain. Notable examples of such theories and algorithms are described in, for example, without limitation, The Physics of Granular Materials, H. Jaeger, S. Nagel, and R. Behringer, Physics Today, April 1996; Mechanics of Granular Materials: Constitutive Behavior and Pattern Transformation, F. Göncü, Ipskamp Drukkers, Enschede, The Netherlands, 2012; O. Pouliquen, C. Cassar, Y. Forterre, P. Jop and M. Nicolas, How Do Grains Flow: Towards A Simple Rheology For Dense Granular Flows, Powders and Grains, 2005; and C. Lieou, A. Elbanna, J. Langer, and J. Carlson, Shear Flow of Angular Grains: Acoustic Effects and Nonmonotonic Rate Dependence of Volume, Physical Review, 2014, the contents which are all expressly incorporated by reference herein.

Furthermore, various embodiments provide a high-nutritional grain, without additives, that does not clump and form bridges even after long storage or high temperature conditions. In some conventional applications, free-flow/anti-caking agents are added as an additive to granular products because some granular products tend to clump. This is due to the cohesive forces between the particles. The strength of the cohesive forces can depend on size, surface structure, and size distribution of the particles. Other factors that may strengthen cohesive attraction are humidity, pressure and temperature. The humidity in the ambient air can cause moisture bridges to form between the particles, which then form lumps.

As mentioned above, moisture or mold can change a dry granular material from one with only repulsive intergrain interactions to one with both repulsive and attractive interactions. The addition of even minuscule amounts of moisture can greatly increase these angles because of the cohesion between the grains. The strength of a material is due to the cohesive forces between atoms. Two atoms or a set of atoms are bonded together by the cohesive forces between the atoms. The two atoms (or sets of atoms) are said to be fractured if the bonds between the atoms are broken by externally applied tensile load to separates the two or more atoms. If a tensile load is applied, the separation between atoms will be increased. The critical values required to break these interatomic bonds are called the theoretical “cohesive” stress. Namely, the theoretical “cohesive” strength estimates the maximum force needed to completely break or separate atomic bonds in solids.

Another aspect of the present teaching that addresses de-clumping is that the apparatus based on the screw design is capable of separating the single grains from each other to break the intergrain bonds as the grain travels along the rotating screws. Rotation of the screws imparts a stress or force upon the treated material that exceeds the theoretical cohesive strength of the treated material. Thus, the contact points and the cohesive forces between the particles are reduced substantially. In addition, the system and method are capable of releasing moisture from the treated material as it moves along the screws so that the final granular product does not form lumps even after long storage or high temperature variations. Consequently, the system and method improve the flow characteristics of the treated grain, without additives. The system and method ensure that the final product retains their flow characteristics. The final product is a high-quality product that retains its free-flowing capability, for example, during downstream processing, at ambient air, and storage at high temperatures and it does not clump. The system and method produce a final product having a humidity barrier wherein the cohesiveness is sufficient to protect the final product against moisture from ambient air.

According to the present teachings, the design of the multiple screws within the extruder can be configured to obtain the flowability of grain according to one or more algorithms as described within the above cited references or generated a final grain product having a predetermined cohesive force. For instance, the flight and/or pitch of the screw can be designed to achieve the desired shear rate or cohesive force as the treated material advances along and between the multiple screws, without introducing heat into the process. For example, a 3-start, 45° pitch flighting zone in the screws will have a higher shear rate than a 2-start, 45 pitch flighting zone. The “start” equals the number of flights that the treated material advances axially each time the screw's body rotates one revolution (360°). The screws according to the present teaching can be designed to have uniformed screw flighting zones or non-uniform flighting zones. By way of example, various flighting zones of the screws may be designed with an increased number of starts of flights per zone, which will have an increased shear rate. For instance, a 1-start flighting zone (i.e., the feed section) has the lowest shear rate. In comparison, a 7-start flighting zone has an extremely high shear rate.

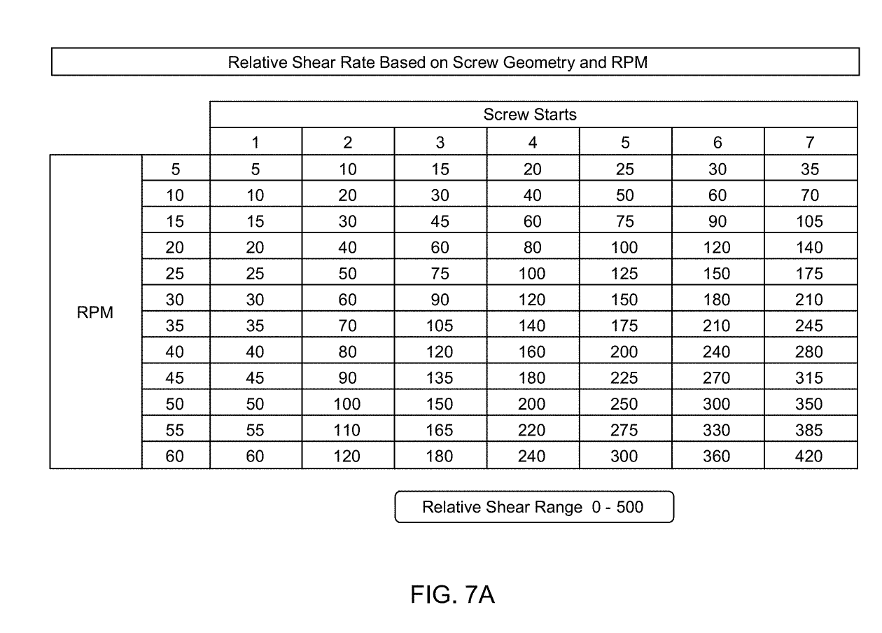

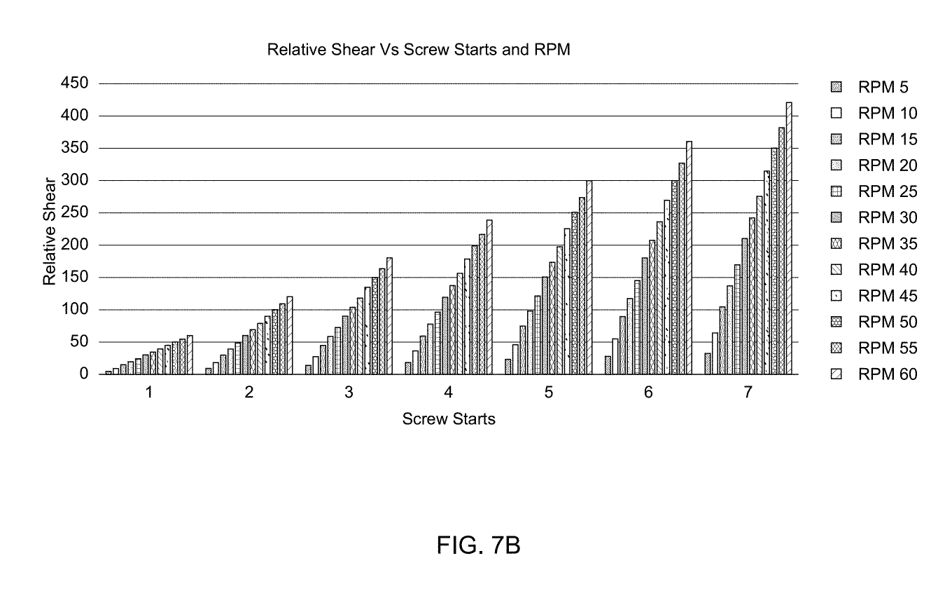

In various embodiments, the amount of shear within the system can be adjusted based, for example, on at least two variables—the screw “start” and the rate of screw rotation. The shear is relatively proportional to the screw start and the rate of screw rotation. The more starts that are included within the design of the screw, the longer and greater the shear points are upon the grain as the screws rotate. Also, the faster the screw rotates causes shearing to occur more frequently within a given time period. Rotation of the screws will produce high shear points for a full revolution of the feed screw. Thus, as shown in the examples of FIG. 7A-7B, relative shear is a constant that depicts the general amount of shear created. Consequently, as the relative shear value doubles, the amount of shear also doubles.

Another screw design factor that influences the shear rate is the distance between the screws. According to the present teaching, the flights and pitches are designed such that they do not contact each other during rotation of the screws. This spacing feature relates to the intermeshing aspects of the screws; namely, the clearance space between the mating parts of the screws. The closer the distance is between the set of screws; the more shearing is generated. However, the farther the screws are distanced from each other, the less shearing will be applied to the treated material during the rotation of the screws.

When fed into the screws, the treated material most likely will have an initial, non-uniform composition, wherein some of the particles within the treated material are larger than others. Passing the treated material between and along the screws during the rotation of the screws breaks down the particles (i.e. composition) within the treated material through shearing and compression which produces a final product having a more uniform composition than the initial composition. In the final product, the particle sizes are uniform, homogenous, and smaller than the initial particle sizes than before the grain is fed into the apparatus.

By breaking down the composition of the grain, the grain releases a small amount of moisture in the range, for example, of approximately ¼% to 2% by weight at the outlet of the apparatus or at the discharge of the screws. In an example where the apparatus is used to treat dried distiller grain, the initial grain temperature may be approximately 180° F.-210° F. The apparatus according to the present teaching can be used to reduce the temperature to approximately 100° F. In various embodiments, the initial grain temperature of the dried distiller grain can be in a range from approximately 100° F.-210° F.

Another advantage of breaking down the grain and the removal of moisture from within the grain is that it produces a final product having a lighter color grain in comparison to the color of the initial grain fed into the apparatus.

Other factors that may be monitored, regulated and/or preset to more precisely control the breaking down of the grain, its flowability, moisture removal, and temperature while providing a thoroughly mixed, uniform, and homogenous final product can include, for example, humidity, pressure and temperature.

In some embodiments, moisture and/or heat may be removed from the process by optionally cooling the grain. In an example, dry distiller grain enters the apparatus at 12% moisture content at 180° Fahrenheit with the water chiller system operating at 40° Fahrenheit, and the dry final product leaves the apparatus at 12% moisture content at 100° Fahrenheit.

### Example 1

Table 1 shows an example that illustrates dry output capacity/day per screw size.

TABLE 1

| Dry Output Capacity/Day | Screw Size (mm) |
|---|---|
| 100-300 tons | 160 mm |
| 301-600 tons | 235 mm |
| 601-900 tons | 320 mm |
| 901-1500 tons | 360 mm |

It should be noted that various embodiment of the device includes a controller (control unit) that controls various sensors and components, such as pressure sensors, humidity sensors, temperature sensors, and drive controls, positioned in various locations throughout the device and connected in a computer control loop to set, maintain and control preselected conditions such as temperature, pressure, humidity, density, flow rate, and residence time in the treated material and/or components of the system. These sensors can be used to monitor the conditions of the barrel and/or treated material so that appropriate adjustments to the grain shear rate, grain cohesive force, distiller grain feeding rate, temperature of the barrel, temperature of the grain, and screw rotation rate are regulated to maintain the treated material within one or more desired operating ranges along the zones of the multiple screw extruder. For example, the shear rate of the grain may be in the range of about 7 times per linear foot per one screw rotation to 49 times per linear foot per screw rotation. The flowability of the treated grain may have a flow rate in the range of about 2 to 6 times the flowability rate of non-treated granular material.

Optionally, in addition to monitoring the shear rate of the grain, the temperature of the grain and the barrel may be monitored and controlled by utilizing a central water chilling system of temperature controlled zones. The chilling system may contain a water based cooling medium that circulates in a closed loop on the barrel's surface, creating conductive/inductive cool transfer from the barrel to the screws and directly to the treated material. The temperature controlled screws convey the grain through the barrel, passing it through a series of temperature controlled cooling zones, which adjusts the grain to the desired temperature.

Some advantages and benefits of the present teachings include, for example, de-clumping the grain; preventing the grain from burning; preserving the nutrients in the grain; producing a lighter colored grain; allowing for steady, flowable grain; modularity such that the apparatus can be integrated and connected to an existing dryer system and allows for temperature control of both the screws and barrel to maintain the desired temperature, for example, a cooling temperature.

It will be apparent to those skilled in the art that various modifications and variations can be made to the system and method of the present disclosure without departing from the scope its teachings.

Other embodiments of the disclosure will be apparent to those skilled in the art from consideration of the specification and practice of the teachings disclosed herein. It is intended that the specification and examples be considered as exemplary only.

What is claimed is:

1. A granular product that has been passed between multiple rotating screws (i) to break down particles within a granular material to a uniform size that is smaller than an initial size of the particles before being passed through the multiple rotating screws such that the granular material releases at least a percentage of moisture, (ii) the granular material is broken down as it passes through the multiple rotating screws to produce a flowable granular composition having a flowable form, without the addition of an additive, and (iii) the granular material is passed between the multiple rotating screws until it assumes a condition whereat the flowable granular composition will not substantially clump or form bridges when the flowable granular composition is in a humid environment, in a subsequent process, during transport or during storage.

2. The granular product according to claim 1, wherein the percentage of moisture released from the granular material is from about ¼% to about 2% by weight.

3. The granular product according to claim 1, wherein the flowable granular composition has a cohesiveness sufficient to withstand humidity in the environment having a temperature of at least ambient air temperature.

4. The granular product according to claim 1, wherein the granular material is passed between the multiple rotating screws such that a force is applied to the granular material to exceed the theoretical cohesive strength of the granular material to break intergrain bonds within the granular material.

5. The granular product according to claim 1, wherein the granular material is passed between the multiple rotating screws at a controlled shear rate to provide flowability characteristics to the granular material to produce the flowable granular composition.

6. The granular product according to claim 1, wherein the granular material is passed between the multiple rotating screws at a shear rate within a range of about 7 times per linear foot per one screw rotation to about 49 times per linear foot per screw rotation.

7. The granular product according to claim 1, wherein the granular material is passed between the multiple rotating screws at a controlled temperature maintained within a predetermined range to provide flowability characteristics to the granular material to produce the flowable granular composition.

8. The granular product according to claim 1, wherein the granular material is passed between the multiple rotating screws while reducing the temperature of the granular material to provide flowability characteristics to the granular material so as to produce the flowable granular composition.

9. The granular product according to claim 1, wherein the granular material has an initial moisture content from about 5% to about 95% by weight before being passed through the multiple rotating screw.

10. The granular product according to claim 1, wherein the granular material comprises a dried distiller grain.

11. The granular product according to claim 1, wherein the granular material comprises a wet distiller grain.

12. The granular product according to claim 1, wherein the flowable granular composition is a final product comprising an animal feed product.

13. The granular product according to claim 1, wherein the multiple rotating screws comprises counter-rotating, intermeshing twin screws.

14. The granular product according to claim 1, wherein one or more of the multiple rotating screws are included within a multiple stage unit including a plurality of extruders connected in multiple stages.

15. The granular product according to claim 1, wherein the flowable granular composition is a final product having a high nutritional content and improved storage characteristics.

16. A de-clumper system comprising:
a first screw configured to receive granular material;
a second screw configured to receive the granular material from the first screw;
at least one barrel that houses at least one of the first screw and the second screw granular product, wherein, as the at least first screw and the second screw rotate breaking down particles within the granular material to have a uniform size that is smaller than an initial size of the particles before being passed through the first and second screws and causing a percentage of moisture within the granular material to be released from at least a portion of a granular material to produce a flowable granular composition having a flowable form, without the addition of an additive, the granular material is passed between the first and second rotating screws until it assumes a condition whereat the flowable granular composition will not substantially clump or form bridges when the flowable granular composition is in a humid environment, in a subsequent process, during transport or during storage.

17. The de-clumper system according to claim 16, wherein the percentage of moisture released from the granular material is about ¼% to about 2% by weight.

18. The de-clumper system according to claim 16, wherein the granular material is passed between the first and second rotating screws such that a force is applied to the granular material to exceed the theoretical cohesive strength of the granular material to break intergrain bonds within the granular material.

19. The de-clumper system according to claim 16, wherein the granular material is passed between the first and second rotating screws at a controlled shear rate to provide flowability characteristics to the granular material to produce the flowable granular composition.

20. The de-clumper system according to claim 16, wherein the granular material is passed between the first and second rotating screws at a controlled temperature maintained within a predetermined range to provide flowability characteristics to the granular material to produce the flowable granular composition.

21. The de-clumper system according to claim 16, wherein the granular material is passed between the multiple rotating screws while reducing the temperature of the granular material to provide flowability characteristics to the granular material so as to produce the flowable granular composition.

22. The de-clumper system according to claim 16, wherein the flowable granular composition is a final product comprising an animal feed product.

23. The de-clumper system according to claim 16, wherein the first and second screws comprises a set of counter-rotating, intermeshing twin screws.

24. The de-clumper system according to claim 16, wherein the flowable granular composition is a final product having a high nutritional content and improved storage characteristics.
